(19) United States
(12) Patent Application Publication
(10) Pub. No.: US 2004/0026870 A1
(43) Pub. Date: Feb. 12, 2004

(54) Face seal assembly with integral support

(76) Inventors: Roy L. Maguire, Edelstein, IL (US); Timothy M. Waters, Peoria, IL (US)

Correspondence Address: CATERPILLAR INC., 100 N.E. ADAMS STREET, PATENT DEPT., PEORIA, IL, 616296490

(21) Appl. No.: 10/213,232

(22) Filed: Aug. 6, 2002

(51) Int. Cl. F16J 15/34

(52) U.S. Cl. 277/377

(57) ABSTRACT

A face seal assembly is provided for use in work machine applications such as track assemblies, roller assemblies, final drives and the like to seal the area between a stationary member and a rotatable member. The face seal assembly includes a seal ring, a resilient load ring and a support member attached to the resilient load ring. The load ring is adapted to apply a load to the seal ring.

### TECHNICAL FIELD

This invention relates generally to a face seal assembly and more particularly to a support member for a resilient load ring of the face seal assembly.

### BACKGROUND

The present invention has particular application to track rollers, final drives, and other components of work machines. The problem of short bearing life in track rollers and final drive assemblies of work machines is one that has continuously plagued the industry. Such work machines typically operate in environments that are highly destructive to seals and consequently to the underlying bearings.

One approach to this problem is the type seal disclosed in U.S. Pat. No. 5,527,046, which issued Jun. 18, 1996 to Bedford and is assigned to the assignee of the present application. This type of face seal has greatly improved track roller bearing life. However, these seals can be damaged during assembly or fail during application. For example, one problem with prior art face seal assemblies involves damage to the resilient load rings. The resilient load ring can be damaged or twist or roll under during assembly. When this occurs, the load ring may allow the dirt and abrasives to pass around the load ring and contaminate the sealed and lubricated bearing areas. Additionally, if the load ring does become damaged it may render the force applied to the face seal ring ineffective. When the force on the face seal rings is reduced, dirt and abrasives can enter at the seal face.

The present invention is directed to overcoming one or more of the problems as set forth above.

### SUMMARY OF THE INVENTION

In one aspect of the present invention a face seal assembly is provided having a central reference axis. The face seal arrangement comprises a seal ring having first and second leg portions. The second leg portion includes a seal face adapted to mate with an abutting member. A resilient load member is adapted to apply a force to the seal ring. The resilient load member has a linear peripheral portion oriented generally parallel to the reference axis, a radial surface substantially perpendicular to the reference axis, and a second linear peripheral portion spaced from the linear peripheral portion. A support member is integrally attached to the second linear peripheral portion of the load member.

### BRIEF DESCRIPTION OF THE DRAWINGS

FIG. 1 is an enlarged diagrammatic sectional view of a portion of one embodiment of a face seal of the present invention;

FIG. 2 is an enlarged diagrammatic sectional view of a portion of an alternate embodiment of a face seal of the present invention; and

FIG. 3 is an enlarged diagrammatic sectional view of a portion of yet another embodiment of a pair of face seals of the present invention.

### DETAILED DESCRIPTION

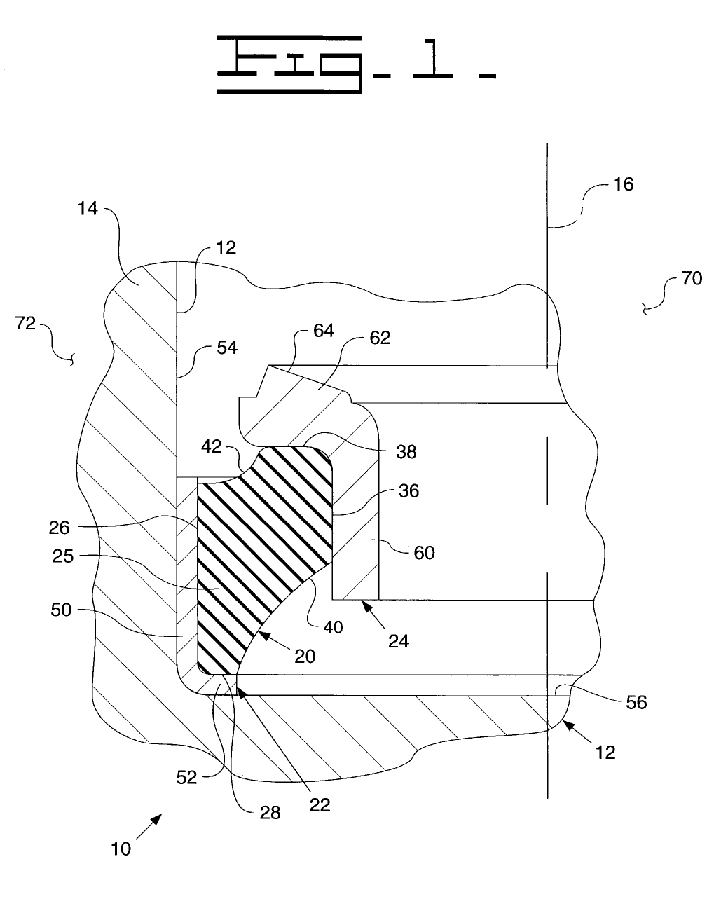

Referring to the drawings and particularly to FIG. 1, a face seal assembly 10 is illustrated and disposed within a counter bore 12 of a housing 14. The face seal assembly 10 has a central reference axis 16 and includes a load resilient load ring 20, a support member 22, and a seal ring 24.

The resilient load ring 20 includes a body portion 25 made from any of a number of known elastomeric materials commonly used to manufacture seals such as rubber compounds, but it could be made from a rubber/metal or rubber/fabric combinations. The body portion 25 of the resilient load ring 20 has a first linear peripheral portion 26 and a first radial portion 28. The first linear peripheral portion 26 is spaced from and extends generally parallel with the axis 16. The first radial portion 28 is generally perpendicular with the axis 16. The resilient load ring 20 also includes a second linear peripheral portion 36 and a second radial portion 38. The second linear peripheral portion 36 is positioned on the opposite side of the body portion 25 and is spaced from first linear peripheral portion 26. The second radial portion 38 is positioned on the opposite side of the body portion 25 parallel to and spaced from the first radial portion 28. A first curved concave surface 40 is positioned between and joins the first radial portion 28 and the second linear peripheral portion 36. A second concave surface 42 is located on the opposite side of the body portion 25 spaced from the first concave surface 40 and is positioned between and joins the first linear peripheral portion 26 and the second radial portion 38. The first concave surface 40 generally has a larger radius than the second concave surface 42.

The support member 22 can be made from a thin steel or rigid plastic material and has a first leg 50 that extends along the first linear peripheral portion 26 and a second leg 52 that extends along the radial portion 28. The support member 22 can be attached to the resilient load ring 20 by any conventional means such as, adhesively bonding or vulcanizing. The termination of the second leg 52 is generally adjacent to the intersection of the first linear peripheral portion 26 and the first concave surface 40 of the resilient load ring 20 and the termination of the first leg portion 50 is generally adjacent to the intersection of the first linear peripheral portion 26 and the second concave surface 42. The first and second legs 50, 52 are configured so as to contact a sidewall 54 and a bottom 56, respectively, of the counter bore 12 of the housing 14.

Seal ring 24 has a first leg 60 that extends along the second linear peripheral portion 36 of the resilient load ring 20 and a second leg portion 62 that extends along the second radial portion 38. A seal face 64 is positioned on the second leg 62 of the seal ring 24 parallel to and spaced from the second radial portion 38 of the resilient load ring 20.

During assembly and in the assembled condition of the face seal arrangement 10, the support member 22 is positioned in the counter bore 12 of the housing 14 with the second linear peripheral portion 36 and the second radial portion 38 of the resilient load ring 20 placed in contact with the seal ring 24. A radial face of an abutting member (not shown) is axially pushed against the seal face 64 of the seal ring 24. In response, the second radial portion 38 of the resilient load ring 20 is urged toward the first radial portion 28. The resilient load ring 20 is adapted to flex in a direction parallel to the central axis 16, which is parallel to a sealed interior 70 of a particular assembly, such as a sealed track link, roller assembly, or final drive not shown.

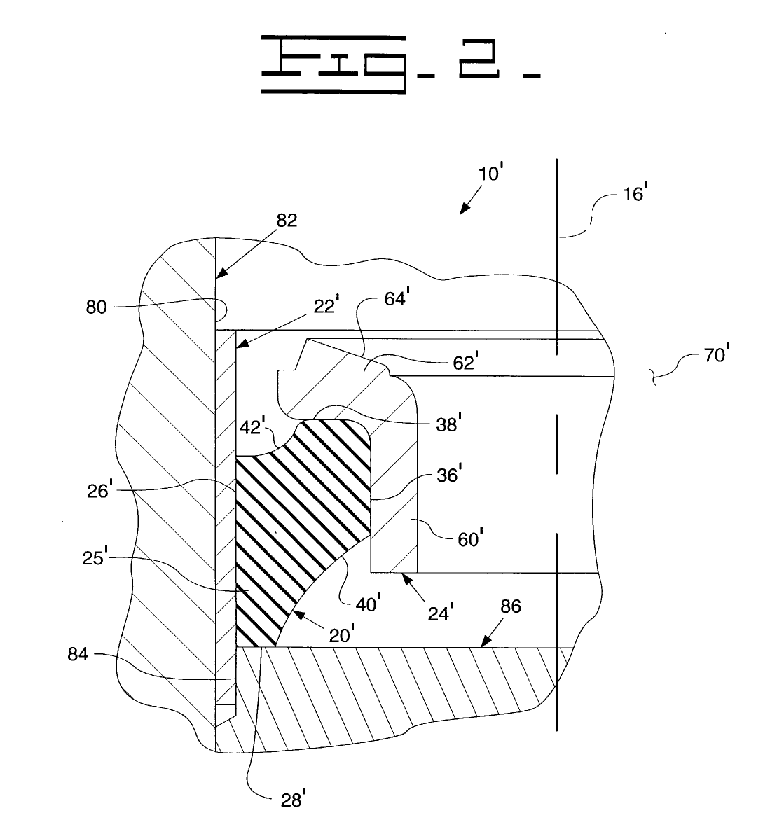

Referring to FIG. 2, an alternate embodiment of the face seal assembly 10 is shown, which is similar to the previously described embodiment. In this alternate embodiment, similar elements are indicated by the same reference numerals with a prime symbol. This embodiment incorporates a face seal assembly 10′ having a central axis 16′ and includes a resilient load ring 20′, a support member 22′ and a seal ring 24′. The resilient load ring 20′ and the seal ring 24′ are functionally and physically similar to the resilient load ring 20 and the seal ring 24 of the previous embodiment.

The support member 22′ has an annular configuration and can be made from a thin steel or rigid plastic material and attached to the first linear peripheral portion 26′ of resilient load ring 20′ by any conventional means such as adhesively bonding or vulcanizing. The support member 22′ of this embodiment is configured for positioning in either a bore 80 of a collar 82 or an outer circumferential surface 84 of a shaft 86 or other similar component. The termination of support member 22′ is shown as extending beyond the intersection of the first linear peripheral portion 26′ and the second concave surface 42′ at one end and extending beyond the intersection of the first linear peripheral portion 26′ and the first radial portion 28′, but could be generally adjacent to both intersection points without changing the function of the face seal assembly 10′.

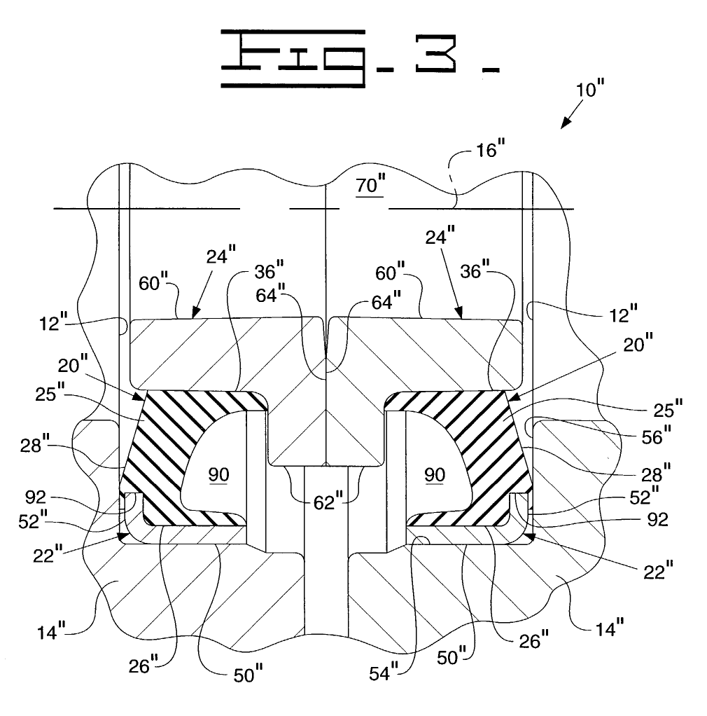

Referring to FIG. 3, yet another alternate embodiment of the face seal assembly 10 is shown, which is similar to the previously described embodiments. In this alternate embodiment, similar elements are indicated by the same reference numerals with a double prime symbol. Face seal assembly 10″ is illustrated having a central reference axis 16″ and includes a pair of load resilient load rings 20″, a pair of support members 22″, and a pair of seal rings 24″.

The pair of resilient load rings 22″ include a body portion 25″ having a first linear peripheral portion 26″ and a radial portion 28″. The first linear peripheral portion 26″ is spaced from and extends generally parallel with the axis 16″. The first radial portion 28″ is generally perpendicular with the axis 16″. The pair of resilient load rings 22″ also include a second linear peripheral portion 36″ spaced from and positioned on the opposite side of the body portion 25″. The first linear peripheral portion 26″ and the second linear peripheral portion 36″ extend from the body portion 25″ and form a cavity/recess 90.

The pair of support members 22″ have a first leg 50″ that extend along the first linear peripheral portion 26″ and a second leg 52″ that extend along the first radial surface 28″. In the subject embodiment, the second leg 52″ is disposed within a stepped portion 92 of the first radial surface 28″ and terminates at the step. A portion of the first radial surface 28″ extends along the outside of the second leg 52″. The termination of the second leg 52″ is generally adjacent to the first radial surface 28″. This point of termination provides back up for the body portion 25″. The first and second legs 50″, 52″ are configured so as to contact a sidewall 54″ and a bottom 56″, respectively, when positioned in the counter bore 12″ of the housing 14″.

Seal ring 24″ has a first leg portion 60″ that extends along the second linear peripheral portion 36″ of the resilient load ring 20″ and a second leg portion 62″ that extends adjacent to the cavity/recess 92 formed by the first linear peripheral portion 26″ and the second peripheral portion 36″. A seal face 64″ is positioned on the second leg portion 62″.

During assembly and in the assembled condition of the face seal arrangement 10″, each of the pair of support members 22″ are positioned in the counter bore 12″ of the housing 14″ with the second linear peripheral portion 36″ of the resilient load ring 20″ placed in contact with the seal ring 24″. The seal face 64″ of each seal ring 24″ are place in abutting relationship to one another and axially pushes against the second linear peripheral portion 36″ of the resilient load ring 20″. In response, the resilient load ring 20″ is adapted to flex in a direction parallel to the central axis 16″, which is parallel to a sealed interior 70″ of a particular assembly, such as a sealed track link, roller assembly, or final drive not shown.

### INDUSTRIAL APPLICABILITY

With reference to the drawings, and the previous detailed description, the subject face seal assembly 10 is particularly useful for increasing the useful life of work machine components such as sealed and lubricated track assemblies, track roller assemblies, final drives and the like. The life of theses components is increased in view of the improved stiffness provided by the support member 22 during placement of the face seal assembly 10 into a particular housing or member. The resilient load ring 20 of the face seal assembly 10 also contributes to increased wear life of machine components by assuring an appropriate force is placed on the seal rings 24. Thus, excluding dirt from the interior of sealed assemblies.

Other aspects, objects and advantages of this invention can be obtained from a study of the drawings, the disclosure and the appended claims.

What is claimed is:

1. A face seal assembly having a central reference axis, the face seal arrangement comprising:
a seal ring including a seal face adapted to mate with an abutting member;
a resilient load ring being adapted to apply a force to said seal ring, said resilient load ring having a first linear peripheral portion oriented generally parallel to the reference axis and a first radial surface oriented generally perpendicular to the reference axis; and
a support member attached to the first linear peripheral portion of said load member.

2. The face seal assembly of claim 1 wherein said support member forms an annular configuration adapted for positioning within a one of a bore of a collar and an outer circumferential surface of a shaft.

3. The face seal assembly of claim 1 wherein said support member includes a first leg and a second leg, the first leg being attached to the first linear peripheral portion of said resilient load ring and the second leg being attached to the first radial surface of said resilient load ring.

4. The face seal assembly of claim 3 wherein said support member is adapted for placement within a counter bore of a housing.

5. The face seal assembly of claim 4 wherein the second leg of said support member is positioned within a stepped portion of the first radial surface of said resilient load ring.

6. The face seal assembly of claim 1 wherein said seal ring includes first and second leg portions, and said resilient load ring includes a second linear peripheral portion and a second radial surface the first and second leg portions contact the second linear peripheral portion and the second radial surface respectively in an assembled state.

7. A face seal assembly defining a reference axis, the face seal arrangement comprising:
a pair of seal rings, each of said seal rings having first and second leg portions, the second leg portion including a seal face adapted to mate with a seal face of a mating seal ring;
a pair of resilient load rings being adapted to apply a force to said seal ring, each of said pair of resilient load rings having a first linear peripheral portion oriented generally parallel to the reference axis, a first radial surface oriented generally perpendicular to the reference axis, and a second linear peripheral portion spaced from the first linear peripheral portion; and
a pair of support members attached to the first linear peripheral portion of each load member.

8. The face seal assembly of claim 7 wherein each of said pair of support members forms an annular configuration adapted for positioning within one of a bore of a collar and an outer circumferential surface of a shaft.

9. The face seal assembly of claim 7 including a cavity positioned between the first linear peripheral portion and the second linear peripheral portion.

10. The face seal assembly of claim 7 wherein each of said pair of support members includes a first leg and a second leg, wherein each first leg being attached to the first linear peripheral portion of a one of said pair of resilient load rings and each second leg being attached to the first radial surface of a one of said pair of resilient load rings.

11. The face seal assembly of claim 10 wherein each of said pair of support members is adapted for placement within a counter bore of a housing.

12. The face seal assembly of claim 11 wherein the second leg of each of said pair of support members is positioned within a stepped portion of the radial surface of each of said pair of resilient load rings.
